(19) United States
(12) Patent Application Publication
(10) Pub. No.: US 2007/0030858 A1
(43) Pub. Date: Feb. 8, 2007

(54) Broadband access device and method thereof

(75) Inventors: Chuanning Chen, Shenzhen (CN); Wumao Chen, Shenzhen (CN); Yangbao Jin, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/492,446

(22) Filed: Jul. 25, 2006

Related U.S. Application Data
(63) Continuation of application No. PCT/CN05/00231, filed on Feb. 25, 2005.

(30) Foreign Application Priority Data
Feb. 25, 2004 (CN) 200410007595.X

(51) Int. Cl. H04L 12/66

(52) U.S. Cl. 370/463

(57) ABSTRACT

A broadband access device comprises a subscriber interface board, a master control board and a backboard, wherein the backboard is configured with a uniform serial bus; the subscriber interface board is configured with an interface unit; and the interface unit is connected to the master control board via the serial bus of backboard. A broadband access method comprises: connecting the master control board and subscriber interface board via a uniform serial bus; transforming the subscriber traffics into serial signal frames by the master control board or the subscriber interface board, and transmitting the serial signal frames to the other board; upon receiving the serial signal frames by the other board, restoring the format of the serial signal frames and transmitting the restored data to corresponding data channel. The present invention achieves broadband access when different access techniques are adopted, simplifies device structure and reduces costs.

This application is a continuation of International Patent Application No. PCT/CN2005/000231, filed on Feb. 25, 2005, which claims priority to Chinese Patent Application No. 200410007595.X, filed on Feb.25, 2004, all of which are hereby incorporated by reference.

### FIELD OF THE INVENTION

The present invention relates to network communication techniques, and more specifically, to a broadband access device and method thereof.

### BACKGROUND OF THE INVENTION

In a system of broadband access network, a networking device for broadband access implements the aggregation function for subscriber lines, converging traffics from subscribers to one or more uplinks and distributing traffics from uplinks to subscribers.

There are two kinds of uplink: Asynchronous Transfer Mode (ATM) uplink in which traffics are encapsulated into ATM cells; Ethernet uplink in which traffics are encapsulated into Ethernet frames.

The broadband access techniques used on subscriber lines include: Digital Subscriber Line (xDSL) access, remote Local Area Network (LAN) access, Hybrid Fiber Coax (HFC) access, etc. Although there are great differences in the principles of theses techniques and in the protocols of physical layer used by these techniques, there are basically only two encapsulation modes used by these techniques: ATM cell encapsulation and Ethernet frame encapsulation.

Because of the different access techniques adopted on the uplink and subscriber lines, independent devices have to be involved in the implementation of connecting uplink with subscriber devices.

Therefore, a broadband subscriber access device includes typically a subscriber interface service board, a backboard and a master control board, wherein the subscriber interface service board is responsible for the physical-layer processing of the subscriber line, i.e., modulation/demodulation, and the adaptation of Layer 2 protocols; the master control board implements device control, data exchange, and uplink processing; and the backboard serves to connect the subscriber interface service board with the master control board.

Usually, the backboard connects the subscriber interface service board with the master control board using the following three types of buses:

(1) ATM bus, i.e., the so-called “ATM kernel” technique, is adopted on the backboard. The ATM kernel means that the access devices adopt ATM switching structure and termination of ATM Layer is implemented by the master control board.

If the ATM cell encapsulation is adopted to encapsulate the subscriber traffics, the adaptation of Layer 2 protocols on the subscriber interface board could be very simple, and the subscriber cells are transmitted transparently in the backboard. If the Ethernet frame encapsulation is adopted, however, the subscriber interface board has to incorporate the function of encapsulation adaptation from Ethernet frame to ATM cell, i.e., the function of ATM Segmentation and Reassembly (SAR), which will increase the cost of subscriber interface board.

(2) Ethernet bus, Fast Ethernet (FE) bus, or Gigabyte Ethernet (GE) bus, i.e., the so-called “IP kernel” technique is adopted on the backboard. The IP kernel means that the access devices adopt Ethernet switching structure and termination of ATM Layer is implemented by the subscriber interface board.

If the Ethernet frame encapsulation is adopted to encapsulate the subscriber traffics, the adaptation of Layer 2 protocols on the subscriber interface board could be very simple, and the subscriber packets are transmitted transparently in the backboard. If the ATM cell encapsulation is adopted, however, the subscriber interface board has to incorporate the function of encapsulation adaptation from Ethernet frame to ATM cell, i.e., the function of ATM SAR, which will also increase the cost of subscriber interface board.

(3) Both ATM bus and Ethernet bus are adopted on the backboard. In this way, no matter which encapsulation mode is adopted, the subscriber interface board does not need the function of ATM SAR. When the subscriber traffics are encapsulated into ATM cells, it could be transmitted transparently via ATM bus, and when the subscriber traffics is encapsulated into Ethernet frames, it could be transmitted transparently via Ethernet bus.

Whereas the above-mentioned method reduces the cost of subscriber interface board compared with the case that only one bus is adopted, the complexity and cost of backboard are increased since two kinds of bus are adopted on the backboard.

### SUMMARY OF THE INVENTION

The present invention provides a broadband access device and a broadband access method.

The broadband access device includes:

a master control board;

a backboard, configured with a uniform serial bus;

a subscriber interface board, configured with an interface unit connected with the master control board via the serial bus, for performing format adaptation between subscriber traffics and serial signal frames of the serial bus.

The broadband access method includes:

connecting a master control board with a subscriber interface board of a broadband access device via a uniform serial bus;

transforming the subscriber traffics which need to be transmitted into serial signal frames of the serial bus by either one of the master control board and the subscriber interface board, and transmitting the serial signal frames to the other one of the two boards;

upon receiving the serial signal frames by the other board, restoring the traffics and transmitting the restored traffics to the corresponding data channel based on the type of the restored traffics.

As can be seen from the above-mentioned device and method, a uniform serial bus is used to transform the traffics from both the uplink and the subscriber line into serial signal frames of the serial bus before exchanging the serial signal frames, thereby ensuring the broadband access in case that different access techniques are adopted on uplink and subscriber lines, simplifying the structures of such devices as the backboard and subscriber interface board and reducing the cost and complexity of broadband access. Since the subscriber interface does not need the finction of segmentation and reassembly, the interface between the subscriber board and the backboard bus can transfer traffics of different types without transformation, which makes the access device applicable to subscriber accesses of different service types. Meanwhile, by adopting a uniform bearer mode, the master control board is able to provide an independent external interface for different services, and the access device meets the flexible networking demand of broadband network.

### BRIEF DESCRIPTION OF THE DRAWINGS

FIG. 1 is a schematic diagram illustrating the internal structure of the broadband access device in accordance with an embodiment of this invention.

FIG. 2 is a schematic diagram illustrating the structure of the digital loop interface unit of the broadband access device shown in FIG. 1.

FIG. 3 is a schematic diagram illustrating the structure of Ethernet interface unit of the broadband access device shown in FIG. 1.

FIG. 4 is a flow chart for processing the traffic inputted from the subscriber line in accordance with the broadband access method of this invention.

FIG. 5 is a flow chart for processing the traffic inputted from the uplink in accordance with the broadband access method of this invention.

FIG. 6 is a schematic diagram illustrating the process of encapsulating ATM cells to LVDS frames in accordance with an embodiment of this invention.

FIG. 7 is a schematic diagram illustrating the process of encapsulating Ethernet frames to LVDS frames in accordance with an embodiment of this invention.

### DETAILED DESCRIPTION OF EMBODIMENTS

This invention will hereinafter be described with reference to the accompanying drawings.

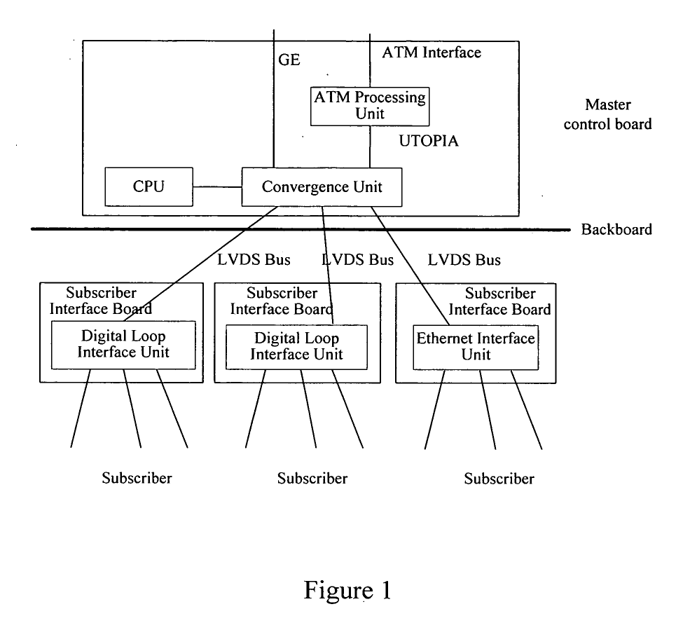

FIG. 1 shows the internal structure of the broadband access device in accordance with the invention. Like a broadband access device in the prior art, the broadband access device of the invention also includes the subscriber interface board, the master control board and the backboard, wherein the subscriber interface board is responsible for physical layer processing of the traffic from the subscriber line, e.g., modulation/demodulation, and the adaptation of Layer 2 protocols; the master control board is used to control the device to implement data exchange and uplink processing; and the subscriber interface board and master control board are connected via the serial bus provided by the backboard.

According to the present invention, there is only one type of bus on the backboard to bear all the service traffics exchanged between the subscriber interface board and the master control board. The bearer bus can be Low Voltage Differential Signaling (LVDS) high speed serial bus as well as other serial buses, such as Current-Mode Logic (CML) bus, Universal Serial Bus (USB), etc., and these serial buses can be the bearer of either ATM service information or other service information such as IP service information. In addition, for the convenience of subscribers accessing from different distances, digital loop interface units for getting different digital-loop subscribers accessed or Ethernet interface units for getting other broadband access devices accessed are provided on different subscriber interface boards, respectively. The digital loop interface unit and Ethernet interface unit are connected to the backboard via the uniform bus, respectively, for transforming data between the format of the subscriber line and the format of the uniform bus. Therefore, the design of the backboard could be very simple. Because of the simple design of the backboard and the adjustable bus speed, the backboard could be widely used in various broadband access devices.

Take the LVDS high speed serial bus as an example, the backboard can then be configured with only this type of bus and no further description is herein given to the structure of the backboard.

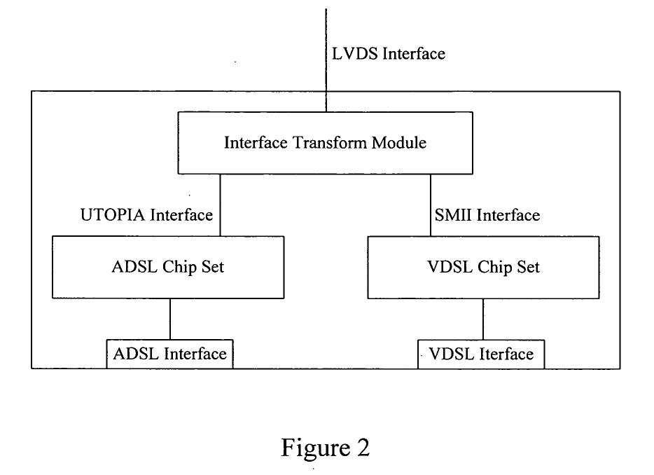

FIG. 2 shows the internal structure of the digital loop interface unit. As shown in FIG. 2, the digital loop interface unit includes the digital loop subscriber interface, the digital loop chip sets and the interface transform module.

The digital loop subscriber interface is used for receiving signals of digital loop subscribers, and several interfaces could be employed for different subscriber signals, such as Asymmetrical Digital Subscriber Loop (ADSL) interface, Symmetrical Digital Subscriber Line (SDSL) interface, Very high bit-rate Digital Subscriber Loop (VDSL) interface and High bit-rate Digital Subscriber Loop (HDSL) interface, etc. FIG. 2 shows two of the interfaces as an example, i.e., ADSL and VDSL interfaces, and in practical applications, one or multiple interfaces could be chosen as required.

The digital loop chip set corresponding to the digital loop subscriber interface is used for obtaining payload information in signals of digital loop subscriber.

The interface transform module is used for encapsulating the payload information obtained from signals of digital loop subscriber into LVDS signal frames, and then sending this payload information to the master control board via the LVDS bus. In the interface transform module, there are interface transform sub-modules corresponding to each of the digital loop subscriber interfaces, mapping different service cells to LVDS frames. For example, an interface transform sub-module which maps ATM cells to LVDS frames corresponds to an ADSL interface which receives and sends subscribers' ATM services, and another interface transform sub-module which implements the processing of Ethernet frames on the bearer of LVDS frames corresponds to a VDSL interface which receives and sends subscribers' Ethernet services. These interface transform sub-modules can be implemented by large-scale digital logic circuit or Application Specific Integrated Circuit (ASIC ) chips, or can be integrated into one module to map different service cells to LVDS frames, as shown in FIG. 2.

In this embodiment, the interface transform module can provide a Universal Test and Operations PHY Interface for ATM (UTOPIA) and a Serial Media Independent Interface (SMII) for IP service inside the broadband access device, thereby be the bearer of ATM service and IP service simultaneously. As a result, it is not necessary to provide the subscriber interface board with SAR function from ATM to Ethernet as required by the pure ATM kernel and pure IP kernel in the prior art, thereby reducing the complexity of transformation on the subscriber interface board as well as the costs.

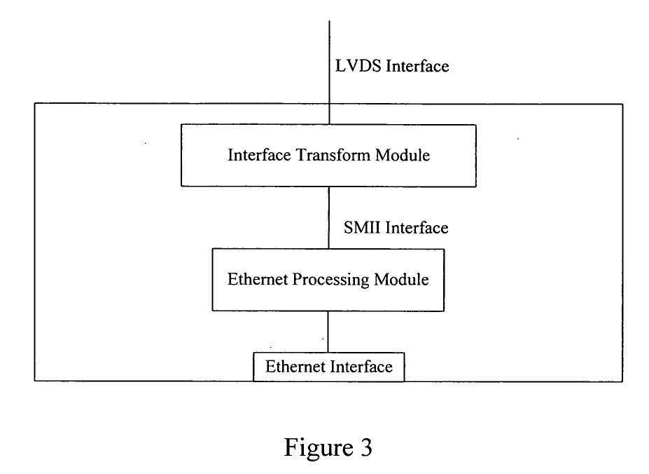

FIG. 3 shows the structure of Ethernet interface unit. As shown in FIG. 3, the Ethernet interface unit includes the Ethernet interface, the Ethernet SAR module and the interface transform module.

The Ethernet interface is used for receiving the Ethernet subscriber signals. Usually, the Ethernet SAR module adopts the cheap commercial Lanswitch chip for use in processing Ethernet frames. The interface transform module is used for encapsulating the payload information in Ethernet subscriber signals into LVDS signal frames, and then transmitting the encapsulated payload information to the master control board via the LVDS bus.

Although the structure of the subscriber interface board is described in the above-mentioned embodiment of this invention, it should be noted that this invention is not limited to the above-mentioned structure, and either the above-mentioned design of providing multiple interfaces by one subscriber interface board or the design of multiple subscriber interface boards providing multiple interfaces, respectively, to get different subscribers accessed may be adopted. Moreover, other broadband access devices can be attached to each of the subscriber interface boards, forming a cascade system. As long as the modifications and alterations conform to the idea of this invention, i.e., a uniform serial bus is adopted as the bearer of service information of different types, they should be covered in the protection scope of this invention.

As shown in FIG. 1, the master control board of the broadband access device includes a CPU, a convergence unit and an ATM processing unit.

The CUP is used for controlling the subscriber interface board to conduct modulation and demodulation of subscriber traffics and adaptation between Layer 2 protocols.

The convergence unit converges the traffic from the LVDS bus of the backboard via its internal serial signal convergence module, differentiates between ATM services and IP services, and then carries out different processing, respectively. Specifically, the convergence unit carries out SAR processing for the traffic which enters an IP network from subscribers of ATM service, and similarly, carries out SAR processing and then sends the processed traffic to the corresponding exit for the traffic which enters an ATM network from subscribers of IP service. In the reversed direction, the traffic of ATM service and IP service received from the uplink at the network side is classified and processed, then transformed to LVDS frames before being transmitted to each of the corresponding subscriber interface boards via the LVDS bus of the backboard. Similarly, the convergence unit has to make the SAR processing of the traffic which is from ATM network to IP service subscribers or from IP network to ATM service subscribers before transmitting the traffic to the subscriber interface board.

The ATM processing unit is used for differentiating different subscribers' ATM cells in the signal frames processed by the convergence unit. When the broadband access device is provided with an ATM interface, the ATM processing unit serves to process ATM services or transform the Virtual Path Identifier (VPI)/ Virtual Channel Identifier (VCI) so as to determine the virtual channel link of ATM services.

In order to meet different demands of broadband networking, multiple interfaces, such as Gigabit Media Independent Interface (GMII) and UTOPIA interface, can be configured in the convergence unit for use in transferring Ethernet traffics and ATM traffics obtained from the LVDS bus, respectively.

As the bearer of information of different transmission networks, the master control board is also configured with multiple GE optical interfaces and ATM optical interfaces for use in transferring Ethernet or ATM traffics to the corresponding uplink optical network ports

It should be understood for those skilled in the art that this invention is not limited to the design described in the embodiment thereof, in which the GE optical interface and ATM optical interface to uplink are configured in the master control board, instead, the invention can have other designs by applying minor modifications to the above-mentioned design, for example, separating the uplink interfaces from the master control board and designing an independent uplink interface board to accommodate the uplink interfaces.

It can be seen from the above-mentioned structure of broadband access device in this invention that the application of uniform bearer serial bus not only simplifies the design of the structure of backboard and reduces costs, but also makes it more convenient to get subscribers of different services accessed by adopting uniform platform for subscribers of different services. Meanwhile, independent interfaces are provided for uplink of ATM service and uplink of IP service, respectively, such that ATM services could be completely independent from IP services, thereby meeting various networking demands.

The idea of the broadband access method of this invention is also based on a uniform bearer bus such that a uniform bearer is provided for different services, which are classified, processed and then sent to the corresponding uplinks.

The procedure of the method in accordance with this invention is hereinafter described in detail with reference to the structure of the device shown in FIG. 1.

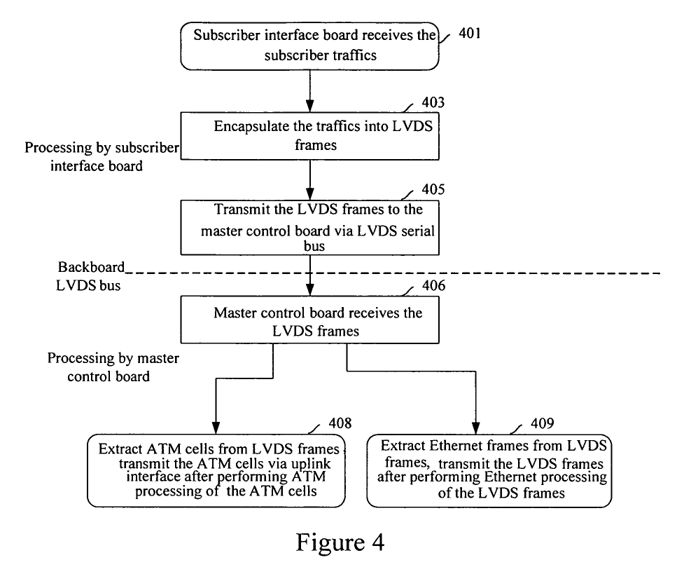

As shown in FIG. 4, the method by which the broadband access device of this invention processes the traffics inputted from subscriber lines includes the steps of:

Step 401: The subscriber interface board receives subscriber traffics of different types, respectively, which include ATM cells and Ethernet frames.

Steps 402˜404: Determine the type of the subscriber traffics received currently.

If the subscriber traffics are ATM cells, proceed to Step 403 of encapsulating the ATM cells into LVDS frames in the Cell Over LVDS mode. The practical operations are very easy, which include transforming the parallel ATM cells to serial signals through parallel/serial transformation, performing the level adaptation if necessary, and transmitting the serial signals via the LVDS serial bus.

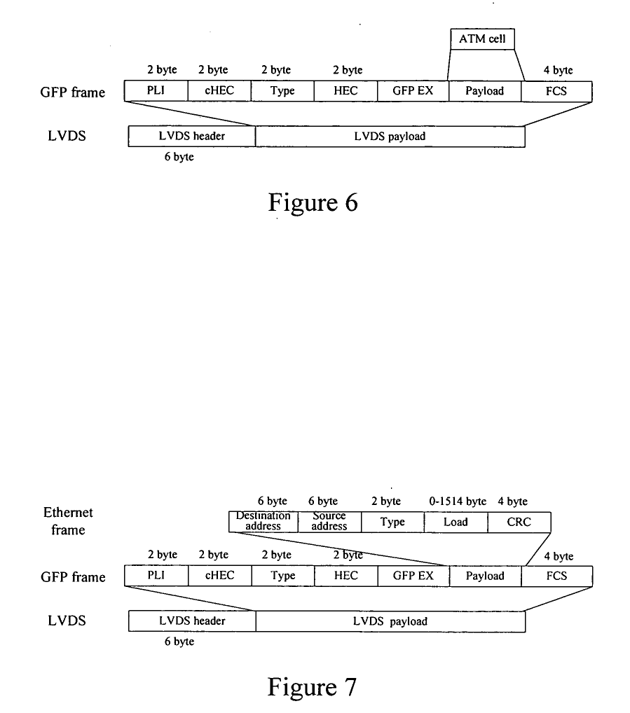

A detailed encapsulation process is shown in FIG. 6. As shown in FIG. 6, the transparent Generic Framing Procedure (GFP) technique is adopted to encapsulate the ATM cells. First ATM cells are encapsulated into the payload field of each GFP frame, then the GFP frames are encapsulated into the LVDS payload of LVDS frames.

If the subscriber traffics are Ethernet frames, proceed to Step 404 of encapsulating the traffics with the Ethernet frame structure into LVDS frames in the Ethernet Over LVDS mode, that is, transforming parallel Ethernet frames into serial signals through parallel/serial transformation, performing the level adaptation if necessary, and then sending the serial signals via the LVDS serial bus.

A detailed encapsulation process is shown in FIG. 7. As shown in FIG. 7, the frame mapping mode is adopted to encapsulate the Ethernet frames of IP services. First the Ethernet frames are encapsulated into the payload field of each GFP frame, and then the GFP frames are encapsulated into the LVDS payload of LVDS frames.

Step 405: The subscriber interface board transmits the encapsulated LVDS frames to the master control board via the LVDS serial bus of the backboard.

The order of Step 403 and Step 404 can be reversed. In the broadband access device illustrated in FIG. 1, if each subscriber interface board provides only one type of subscriber interface for subscriber traffics, Steps 402 to 404 are not necessary, and the subscriber interface board could directly transform the received subscriber traffics to LVDS frames and transmit the transformed traffics via the LVDS serial bus.

Step 406: The master control board receives the LVDS frames via the LVDS bus of backboard, and then converges the LVDS frames of different services.

Steps 407˜409: The master control board decides whether the traffics encapsulated in the LVDS frames are ATM cells or Ethernet frames.

If the traffics are ATM cells, proceed to Step 408 to extract ATM cells from the LVDS frames, perform ATM processing, perform SAR processing for the traffic which enters an IP network from a subscriber of ATM service, and transmit the processed ATM traffics via the corresponding uplink interface.

If the traffics are Ethernet frames, proceed to Step 409 to extract Ethernet frames from the LVDS frames, perform Ethernet processing, perform SAR processing for the traffic which enters an ATM network from a subscriber of IP service, and transmit the processed Ethernet traffics via the corresponding uplink interface.

In order to realize the above-mentioned judging step, the subscriber interface board adds identifiers to different subscriber traffics while encapsulating the subscriber traffics into LVDS frames, for instance, the subscriber interface board receiving ATM cells adds “01” to the header of the LVDS frame as the identifier while encapsulating the subscriber traffics; the subscriber interface board receiving Ethernet frames adds “02” to the header of the LVDS frame as the identifier while encapsulating the subscriber traffics. In this way, the master control board can determine the traffic type according to the identifier in the header of the LVDS frame upon receiving the LVDS frame from the backboard.

The order of the above-mentioned Step 408 and Step 409 could be reversed. In the broadband access device shown in FIG. 1, if there is a fixed corresponding relationship between the subscriber interface board and the LVDS bus which is connected to the master control board, and the LVDS frames containing subscriber traffics are encapsulated respectively according to the type of subscriber traffics, Steps 407 to 409 could be skipped.

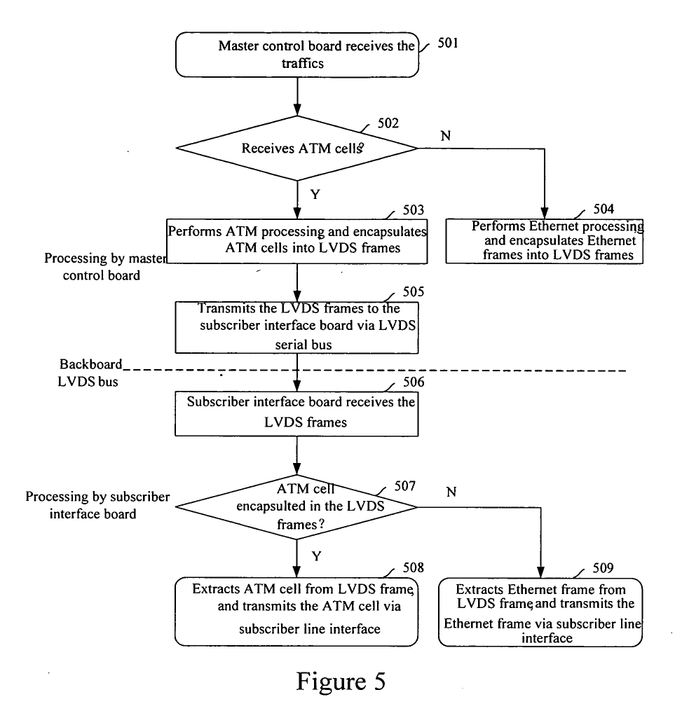

As shown in FIG. 5, the procedure by which the broadband access device processes the traffics inputted from uplinks of the network side comprises the steps of:

Step 501: The master control board receives the uplink traffics of different types, which include ATM cells and Ethernet frames.

Steps 502˜504: The master control board sorts the ATM and IP traffics received from uplinks of the network side, i.e., deciding whether the traffics are ATM cells or Ethernet frames.

If the traffics are ATM cells, proceed to Step 503 to perform necessary ATM processing, perform SAR processing for the traffics that are sent from ATM network to an IP service subscriber, and encapsulate the ATM cells into LVDS frames in the Cell Over LVDS mode.

If the traffics are Ethernet frames, proceed to Step 504 to perform necessary Ethernet processing, perform SAR processing for the traffics that are sent from IP network to an ATM service subscriber, and encapsulate the Ethernet frames into LVDS frames in the Ethernet Over LVDS mode.

Step 505: The master control board transmits the encapsulated LVDS frames to the subscriber interface board via the LVDS serial bus.

The order of above-mentioned Step 503 and Step 504 can be reversed.

Step 506: The subscriber interface board receives the LVDS frames.

Steps 507˜509: The subscriber interface board decides whether it is ATM cells or Ethernet frames that are encapsulated in the LVDS frames.

If ATM cells are encapsulated in the LVDS frames, proceed to Step 508 to extract the ATM cells from the LVDS frames, and then transmit the extracted ATM cells via the corresponding interface of subscriber line.

If Ethernet frames are encapsulated in the LVDS frames, proceed to Step 509 to extract the Ethernet frames from the LVDS frames, and then transmit the extracted Ethernet frames via the corresponding interface of subscriber line.

The foregoing is only preferred embodiments of this invention and is not intended to limit the protection scope thereof.

1. A broadband access device, comprising:
a master control board;
a backboard, configured with a uniform serial bus;
a subscriber interface board, configured with an interface unit connected with the master control board via the serial bus, for performing format adaptation between subscriber traffics and serial signal frames of the serial bus.

2. The device according to claim 1, wherein the interface unit comprises:
a digital loop interface unit for getting digital loop subscribers accessed, or an Ethernet interface unit for getting other broadband access devices accessed.

3. The device according to claim 2, wherein the digital loop interface unit comprises at least one of:
a digital loop subscriber interface, for receiving and sending the traffics of digital loop subscriber;
a digital loop chip set, for obtaining payload information from the traffics of digital loop subscriber;
an interface transform module, for encapsulating the payload information obtained from the signal of digital loop subscriber into the serial signal frames of the serial bus and transforming the serial signal frames received from the serial bus into the traffics of digital loop subscriber.

4. The device according to claim 3, wherein the digital loop subscriber comprises at least one of: asymmetrical digital loop subscriber, symmetrical digital loop subscriber, hyper speed digital loop subscriber and high bit rate digital loop subscriber;
the digital loop subscriber interface comprises at least one of:
an asymmetrical digital loop interface, for receiving and sending the traffics of asymmetrical digital loop subscriber;
a symmetrical digital loop interface, for receiving and sending the traffics of symmetrical digital loop subscriber;
a hyper speed digital loop interface, for receiving and sending the traffics of hyper speed digital loop subscriber; and
a high bit rate digital loop interface, for receiving and sending the traffics of a high bit rate digital loop subscriber.

5. The device according to claim 1, wherein the master control board comprises:
a convergence unit, for converging all the serial signal frames received via the serial bus, obtaining the subscriber traffics by classifying the serial signal frames, processing the classified serial signal frames, and transmitting the subscriber traffics to the corresponding port at the network side; as well as classifying the subscriber traffics received from the network side, processing the classified subscriber traffics and transforming the subscriber traffics into serial signal frames, and transmitting the serial signal frames to the serial bus.

6. The device according to claim 5, wherein the master control board further comprises:
a CPU, connected with the convergence unit, for controlling the subscriber interface board to make physical layer processing of the subscriber traffics and perform adaptation of Layer 2 protocols;
an Asynchronous Transfer Mode (ATM) processing unit, connected with the convergence unit, for distinguishing different subscribers' ATM cells in the serial signal frames received and processed by the convergence unit.

7. The device according to claim 6, wherein the convergence unit comprises:
a serial signal convergence module, for distinguishing different services on the serial bus and obtaining the corresponding service information;
at least one Ethernet interface, for sending Ethernet traffics obtained by the serial signal convergence module;
a Universal Test and Operations PHY Interface for ATM (UTOPIA), for transmitting ATM traffics obtained by the serial signal convergence module to the ATM processing unit.

8. The device according to claim 5, wherein the master control board further comprises:
at least one Gigabyte Ethernet (GE) optical interface, for transforming the traffics sent from the Ethernet interface and transmitting the transformed traffics to the corresponding uplink port of optical network;
at least one ATM optical interface, for transforming different subscribers' ATM cells processed by the ATM processing unit and transmitting the transformed traffics to the corresponding uplink port of optical network.

9. The device according to claim 2, wherein the master control board comprises:
a convergence unit, for converging all the serial signal frames received via the serial bus, obtaining the subscriber traffics by classifying the serial signal frames, processing the classified serial signal frames, and transmitting the subscriber traffics to the corresponding port at the network side; as well as classifying the subscriber traffics received from the network side, processing the classified subscriber traffics and transforming the subscriber traffics into serial signal frames, and transmitting the serial signal frames to the serial bus.

10. The device according to claim 9, wherein the master control board further comprises:
a CPU, connected with the convergence unit, for controlling the subscriber interface board to make physical layer processing of the subscriber traffics and perform adaptation of Layer 2 protocols;
an Asynchronous Transfer Mode (ATM) processing unit, connected with the convergence unit, for distinguishing different subscribers' ATM cells in the serial signal frames received and processed by the convergence unit.

11. The device according to claim 10, wherein the convergence unit comprises:
a serial signal convergence module, for distinguishing different services on the serial bus and obtaining the corresponding service information;
at least one Ethernet interface, for sending Ethernet traffics obtained by the serial signal convergence module;
a Universal Test and Operations PHY Interface for ATM (UTOPIA), for transmitting ATM traffics obtained by the serial signal convergence module to the ATM processing unit.

12. The device according to claim 9, wherein the master control board further comprises:
at least one Gigabyte Ethernet (GE) optical interface, for transforming the traffics sent from the Ethernet interface and transmitting the transformed traffics to the corresponding uplink port of optical network;
at least one ATM optical interface, for transforming different subscribers' ATM cells processed by the ATM processing unit and transmitting the transformed traffics to the corresponding uplink port of optical network.

13. The device according to claim 3, wherein the master control board comprises:
a convergence unit, for converging all the serial signal frames received via the serial bus, obtaining the subscriber traffics by classifying the serial signal frames, processing the classified serial signal frames, and transmitting the subscriber traffics to the corresponding port at the network side; as well as classifying the subscriber traffics received from the network side, processing the classified subscriber traffics and transforming the subscriber traffics into serial signal frames, and transmitting the serial signal frames to the serial bus.

14. The device according to claim 13, wherein the master control board further comprises:
a CPU, connected with the convergence unit, for controlling the subscriber interface board to make physical layer processing of the subscriber traffics and perform adaptation of Layer 2 protocols;
an Asynchronous Transfer Mode (ATM) processing unit, connected with the convergence unit, for distinguishing different subscribers' ATM cells in the serial signal frames received and processed by the convergence unit.

15. The device according to claim 14, wherein the convergence unit comprises:
a serial signal convergence module, for distinguishing different services on the serial bus and obtaining the corresponding service information;
at least one Ethernet interface, for sending Ethernet traffics obtained by the serial signal convergence module;
a Universal Test and Operations PHY Interface for ATM (UTOPIA), for transmitting ATM traffics obtained by the serial signal convergence module to the ATM processing unit.

16. The device according to claim 13, wherein the master control board further comprises:
at least one Gigabyte Ethernet (GE) optical interface, for transforming the traffics sent from the Ethernet interface and transmitting the transformed traffics to the corresponding uplink port of optical network;
at least one ATM optical interface, for transforming different subscribers' ATM cells processed by the ATM processing unit and transmitting the transformed traffics to the corresponding uplink port of optical network.

17. The device according to claim 4, wherein the master control board comprises:
a convergence unit, for converging all the serial signal frames received via the serial bus, obtaining the subscriber traffics by classifying the serial signal frames, processing the classified serial signal frames, and transmitting the subscriber traffics to the corresponding port at the network side; as well as classifying the subscriber traffics received from the network side, processing the classified subscriber traffics and transforming the subscriber traffics into serial signal frames, and transmitting the serial signal frames to the serial bus.

18. The device according to claim 17, wherein the master control board further comprises:
a CPU, connected with the convergence unit, for controlling the subscriber interface board to make physical layer processing of the subscriber traffics and perform adaptation of Layer 2 protocols;
an Asynchronous Transfer Mode (ATM) processing unit, connected with the convergence unit, for distinguishing different subscribers' ATM cells in the serial signal frames received and processed by the convergence unit.

19. The device according to claim 18, wherein the convergence unit comprises:
a serial signal convergence module, for distinguishing different services on the serial bus and obtaining the corresponding service information;
at least one Ethernet interface, for sending Ethernet traffics obtained by the serial signal convergence module;
a Universal Test and Operations PHY Interface for ATM (UTOPIA), for transmitting ATM traffics obtained by the serial signal convergence module to the ATM processing unit.

20. The device according to claim 17, wherein the master control board further comprises:
at least one Gigabyte Ethernet (GE) optical interface, for transforming the traffics sent from the Ethernet interface and transmitting the transformed traffics to the corresponding uplink port of optical network;
at least one ATM optical interface, for transforming different subscribers' ATM cells processed by the ATM processing unit and transmitting the transformed traffics to the corresponding uplink port of optical network.

21. A broadband access method, comprising:
connecting a master control board with a subscriber interface board of a broadband access device via a uniform serial bus;
transforming the subscriber traffics which need to be transmitted into serial signal frames of the serial bus by either one of the master control board and the subscriber interface board, and transmitting the serial signal frames to the other one of the two boards;
upon receiving the serial signal frames by the other board, restoring the traffics and transmitting the restored traffics to the corresponding data channel based on the type of the restored traffics.

22. The method according to claim 9, comprising:
encapsulating the subscriber traffics sent from subscribers into the serial signal frames of the serial bus and transmitting the serial signal frames to the master control board via the serial bus by the subscriber interface board;
converging the subscriber traffics of the same type according to the service type of the subscriber traffics received from the serial bus, and transmitting the subscriber traffics via the corresponding data interface by the master control board;
encapsulating the subscriber traffics from the network side into the serial signal frames of the serial bus and transmitting the serial signal frames to the corresponding subscriber interface board via the serial bus by the master control board;
extracting the subscriber traffics from the serial signal frames received from the serial bus and transmitting the subscriber traffics to corresponding subscriber by the subscriber interface board.
